(19) United States
(12) Patent Application Publication
(10) Pub. No.: US 2019/0387492 A1
(43) Pub. Date: Dec. 19, 2019

(54) NETWORK DEVICE INSTALLATION AND LOCATION-SPECIFIC REMOTE CONFIGURATION OF NETWORK DEVICES

(71) Applicant: HEWLETT PACKARD ENTERPRISE DEVELOPMENT LP, Houston, TX (US)

(72) Inventors: Neil Kulkarni, Santa Clara, CA (US); Girish Hariharasubramani, Chennai (IN); Kishore Krishna Seshadri, Santa Clara, CA (US); Ramanan Subramanian, Santa Clara, CA (US)

(21) Appl. No.: 16/010,955

(22) Filed: Jun. 18, 2018

(51) Int. Cl. H04W 64/00; H04L 12/24

(52) U.S. Cl. CPC H04W 64/003; H04L 41/0806

(57) ABSTRACT

A method including receiving, by a server from a mobile device, an identifier of a network device to be installed in a network and a location information associated with the network device, is provided. The mobile device is located near the network device that is remote to the server, and the method includes determining, by the server, an installation configuration for the network device, and providing, by the server, the installation configuration for the network device to the mobile device.

### BACKGROUND

### Background

Network administrators typically handle hundreds or more network devices located over multiple locations, each network device having different configuration settings and servicing different needs and types of clients. When a network connectivity problem arises, it becomes difficult to handle the multiplicity of network devices and configurations that may be in place. The first step for efficiently managing a centralized network provider is to have a strong installation strategy for each of the myriad of network devices that are continually being deployed into or retired from a network. Current systems rely on the capability of individual installers to perform the correct installation procedures and to install the correct network device on each instance. Coordination and management of the installation process is typically performed haphazardly and on a case-by-case basis. Most revisions and corrections are performed once a problem is detected, and after precious time has been spent trying to identify the origin of a problem.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture suitable for a remotely controlled network device installation, according to some embodiments.

FIG. 2 is an architecture illustrating an example network device and client device from the architecture of FIG. 1, according to certain aspects of the disclosure.

FIGS. 3A-C illustrate a dashboard in a remote installer control application for a network device installation, according to some embodiments.

FIGS. 4A-E illustrate screenshots of an installer application for a network device installation, according to some embodiments.

FIG. 5 is a flow chart illustrating steps in a method for remotely controlling a network device installation, according to some embodiments.

FIG. 6 is a flow chart illustrating steps in a method for a network device installation with a location-specific remotely downloaded configuration, according to some embodiments.

FIG. 7 is a block diagram illustrating an example computer system with which the client and network device of FIGS. 1 and 2 and the methods of FIGS. 5 and 6 can be implemented.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

The present disclosure addresses the problem arising in computer technology wherein a distributed network provider performs a location-specific configuration for installing network devices. Multiple network devices distributed over multiple locations create the problem of centralized management of the device installation, respecting the different configuration settings of each device in each location. The task may include installing network devices for local area networks (LANs) in venues such as retail stores, branch offices, factories, warehouses, hospitals, clinical laboratories, restaurants, and various other locations. As the number of locations that a network provider serves continues to increase, it is desirable to enable connectivity for each location in a centralized manner.

Embodiments as disclosed herein enable network administrators to control the installation process on each network device, and have a better understanding of a network or network device failure if and when it arises, rather than relying on the personal capabilities of a customer, which may vary largely from one deployment to another.

Embodiments as disclosed herein resolve the problem in network based computer technology for installing a variety of different network devices to be installed in different locations, or within the same location.

The proposed solution further enables a network administrator to group installed network devices according to type, regional area, and the like, to have a broader scope and more comprehensive understanding of the distributed network. This facilitates the resolution of any network connectivity problem and the handling of updates and maintenance operations over the entire network. Further, embodiments as disclosed herein enable a network administrator to have a better control over multiple installers and other personnel attending the network. For example, in some embodiments, the network administrator may adjust, change, or cancel operational privileges to installers based on performance, abilities, and workload.

In one embodiment of the present disclosure, a computer-implemented method is described that includes receiving, by a server from a mobile device, an identifier of a network device to be installed in a network and a location information associated with the network device, wherein the mobile device is located near the network device that is remote to the server. The computer-implemented method also includes determining, by the server, an installation configuration for the network device, and providing, by the server, the installation configuration for the network device to the mobile device.

According to one embodiment, a system is described that includes a memory storing instructions and one or more processors configured to execute the instructions to receive, by a server from a mobile device, an identifier of a network device to be installed in a network and a location information associated with the network device, wherein he mobile device is located near the network device that is remote to the server. The one or more processors further execute instructions to determine, by the server, an installation configuration for the network device and to provide, by the server, the installation configuration for the network device to the mobile device.

According to one embodiment, a non-transitory, machine readable medium is described that includes instructions, which when executed by one or more processors, cause a computer to perform a method, the method including receiving, by a server from a mobile device, an identifier of a network device to be installed in a network and a location information associated with the network device. The mobile device is located near the network device that is remote to the server. The method also includes determining, by the server, an installation configuration for the network device, and providing, by the server, the installation configuration for the network device to the mobile device.

In yet other embodiment, a system is described that includes a means for storing commands and a means for executing the commands causing the system to perform a method that includes receiving, by a server from a mobile device, an identifier of a network device to be installed in a network and a location information associated with the network device. The mobile device is located near the network device that is remote to the server. The method also includes determining, by the server, an installation configuration for the network device, and providing, by the server, the installation configuration for the network device to the mobile device.

In one embodiment, a computer-implemented method as disclosed herein includes providing, from a mobile device to a server, an identifier of a network device to be installed in a network and a location information associated with the network device, wherein the mobile device is located near the network device that is remote to the server. The computer-implemented method also includes receiving, at the mobile device from the server, an installation configuration for the network device, and installing, in the network device, the installation configuration.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### Example System Architecture

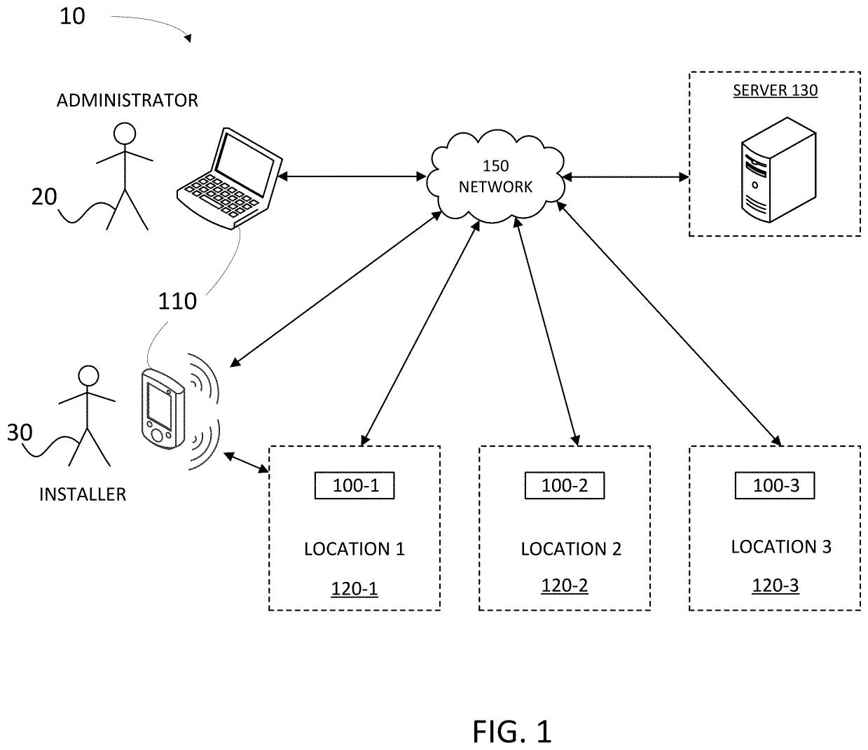

FIG. 1 illustrates an example architecture 10 suitable for a remotely controlled network device installation, according to some embodiments. Architecture 10 includes server 130 and client devices 110 connected over a network 150. Server 130 is configured to host a memory including instructions which, when executed by a processor, cause the server 130 to perform at least some of the steps in methods as disclosed herein. In some embodiments, the processor is configured to perform an application running in one or more of client devices 110. Client devices 110 may include a laptop, desktop, or any other computer device used by an administrator 20 of server 130. Further, in some embodiments, client devices 110 may include a mobile device, a smart phone, a tablet, or any other portable computing device capable to communicate with server 130 through network 150, used by an installer 30. For purposes of load balancing, multiple servers 130 can host memories including instructions to one or more processors to perform an instance of one of multiple functions to complete the application.

Architecture 10 may also include multiple locations, e.g., location 1 120-1, location 2 120-2, and location 3 120-3 (hereinafter, collectively referred to as “locations 120”). Locations 120 may be within the coverage of local area networks (LANs, wireless LANs, WLANs, and the like) serviced by network devices 100-1, 100-2, and 100-3 (hereinafter, collectively referred to as “network devices 100”). Network devices 100 may be any device used to handle data communication in a network, e.g., a node, a switch, a multiplexer, a router, or an access point. In that regard, network devices 100 may include any one of a wired terminal (e.g., a copper cable, a fiber optic cable), or a wireless and/or Internet of Things (IoT) terminal (e.g., Wi-Fi, Bluetooth, Zigbee, cellular network, and the like), or any combination thereof. Accordingly, network devices 100 may be communicatively coupled with server 130 through network 150, and with at least some of client devices 110 (e.g., a mobile phone, a smart phone, a tablet, used by installer 30). In some embodiments, installer 30 visits at least one of locations 120 to install appropriate configuration parameters in network devices 100 according to protocols, rules, and services specified and supported by server 130. In that regard, network devices 100 may include instant access points (IAPs) that can act as virtual controllers, routers, hubs, network switches, wireless controllers, and the like, and locations 120 may include retail stores, businesses (e.g., restaurants, shopping malls, and the like), factories, and the like.

More generally, locations 120 may include any area of space wherein a customer may desire to establish a LAN, either for performing business/operational transactions to employees and staff, or to provide a service to customers (e.g., a Wi-Fi connection to patrons in a restaurant or coffee shop). In that regard, each of locations 120 may include one or more of network devices 100. Moreover, different network devices 100 may have different configuration settings in terms of requirements and capabilities, access and privileges, based on the locations 120, or within the same location based on type of device, and intended purpose. Embodiments as disclosed herein provide methods and systems to manage the different requirements and configurations of the multiple network devices 100 in architecture 10 by administrator 20, especially at the time of installation of each of network devices 100.

Server 130 may include any device having an appropriate processor, memory, and communications capability for providing installation configurations to multiple network devices 100. Any one of server 130 may be accessible by various client devices 110 over network 150. Client devices 110 can be, for example, desktop computers, mobile computers, tablet computers (e.g., including e-book readers), mobile devices (e.g., a smartphone or PDA), or any other devices having appropriate processor, memory, and communications capabilities for accessing the network device application in one or more of server 130. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

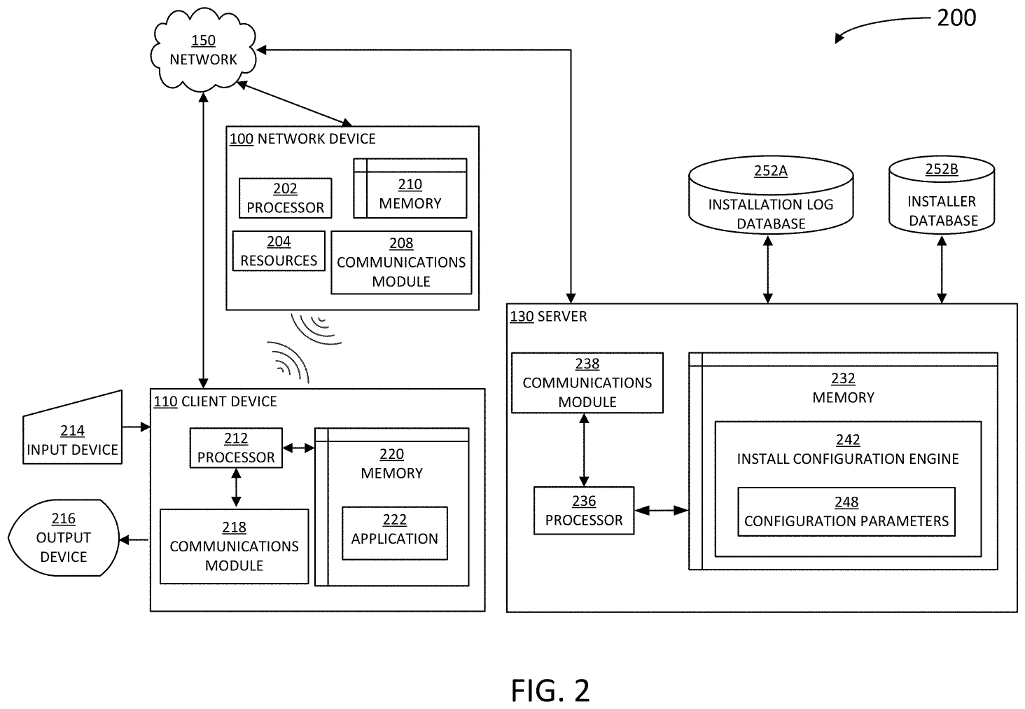

FIG. 2 is a network architecture 200 illustrating an example server 130, client device 110, and a network device 100 in architecture 10 of FIG. 1, according to certain aspects of the disclosure. Network device 100 and client device 110 are communicatively coupled with server 130 over network 150 via communications modules 208 (network device 100), 218 (client device 110), and 238 (server 130). Communications modules 208, 218, and 238 are configured to interface with network 150 to send and receive information, such as data, requests, responses, and commands to other devices on the network. Communications modules 208, 218, and 238 can be, for example, modems or Ethernet cards. Moreover, communication modules 208 and 218 may include a wireless communication antenna so that client device 110 may locally interact with network device 100 through an LAN, or on a device-to-device handshake basis. For example, in some embodiments, client device 110 may assess a proper installation configuration for network device 100, and enable a download of installation scripts from server 130 to network device 100, through network 150. Client device 110 may also be coupled with an input device 214 and an output device 216. Input device 214 may include a mouse, a keyboard, a touchscreen, and the like. Output device 216 may include a display, a touchscreen, a microphone, and the like. In some embodiments, input device 214 and output device 216 may be included in the same unit (e.g., a touchscreen).

Server 130 includes a memory 232, a processor 236, and communications module 238. Processor 236 is configured to execute instructions, such as instructions physically coded into processor 236, instructions stored in memory 232, or a combination of both. Client device 110 also includes a memory 220 storing instructions to be executed by processor 212, such as an application 222. In some embodiments, an application 222 in client device 110 may be installed by server 130 and perform scripts and other routines provided by server 130. Execution of application 222 may be controlled by a processor 212 in client device 110. For example, in some embodiments, client device 110 may be a laptop or desktop used by an administrator (e.g., administrator 20) and application 222 is an installer control application that manages multiple installers and multiple network devices in multiple remote locations (e.g., installer 30, network devices 100, and locations 120). Additionally, in some embodiments, application 222 may include an installer application and client device 110 may be a mobile device (e.g., a smart phone, a tablet, and the like) used by an installer to install network devices in remote locations (e.g., installer 30, network devices 100, and locations 120). Network device 100 also includes a processor 202 and a memory 210 storing instructions to be executed by processor 202, and other data (e.g., installation configuration scripts provided by server 130). In some embodiments, network device 100 also includes resources 204 to handle networking operations within a LAN, WLAN, Wi-Fi, Bluetooth and the like, provided by network device 100 within a specific location (e.g., locations 120). Accordingly, processor 202 may also be configured to operate and control resources 204 using the installation configuration in memory 210. Resources 204 may include hardware and software components, such as input/output ports, network interface circuits (NICs), serializer-deserializer (SERDES) circuits, multiplexer-demultiplexer (MUX-DEMUX) circuits, radio-frequency (RF) antennas and controller circuits, and the like.

Memory 232 includes an install configuration engine 242 configured to receive requests from a user for performance parameters of the network device. In some embodiments, install configuration engine 242 supports micro service extension capabilities to troubleshoot server 130, including specific business-critical applications. In some embodiments, install configuration engine 242 has full access to an installation log database 252A and an installer database 252B (hereinafter, collectively referred to as “databases 252”). Installation log database 252A may include files, notes, and other information relevant to the installation of each of the network devices, aggregated over one or more of the locations and the installers. Some of these files may include images, videos, and other multimedia files recording the specific installation configuration of a network device. Installer database 252B may include scripts and other configuration information (e.g., settings, requirements, rules, and protocols) for previously installed network devices, or for different types of network devices.

Configuration parameters 248 include parameters used in the configuration of the network devices and other relevant information for the maintenance and operation of network devices hosted or serviced by server 130 (e.g., network devices 100). In some embodiments, at least one of configuration parameters 248 is tailored to a specific device based on the location of the network device, the type of network device, and certain privileges and access granted to the network device.

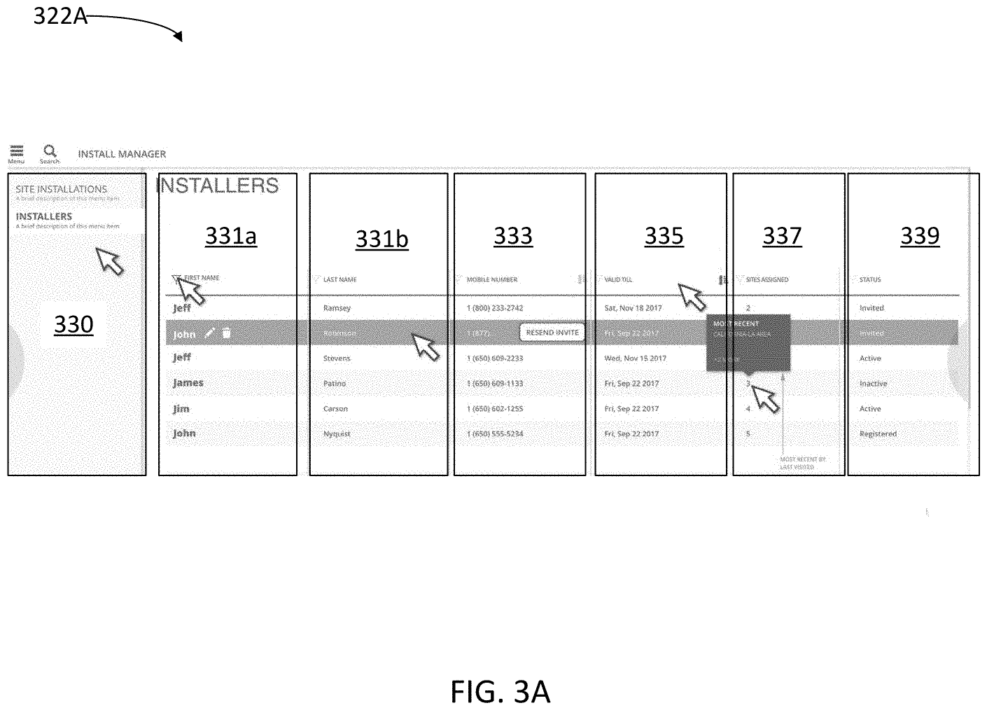

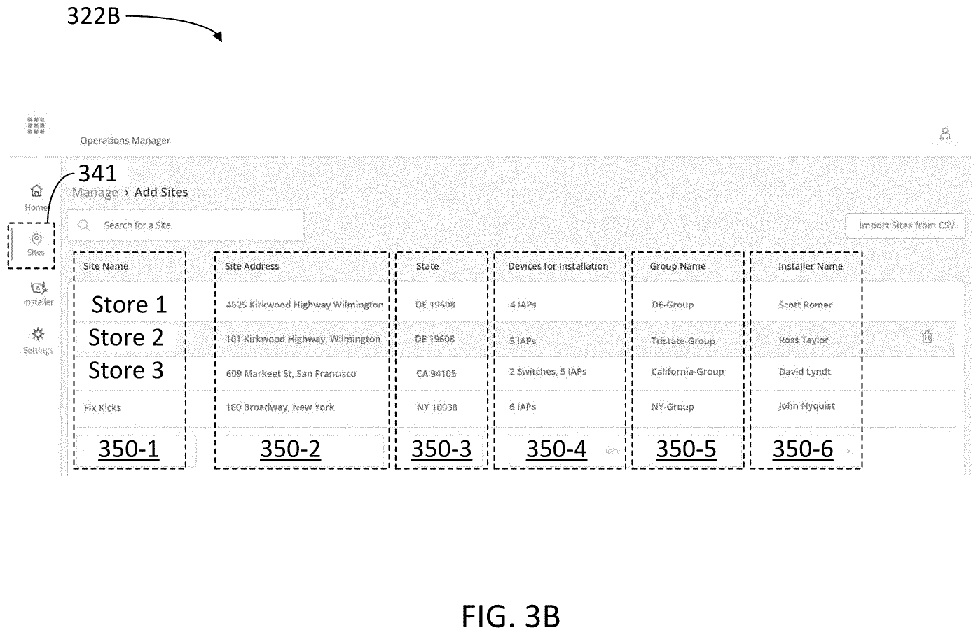

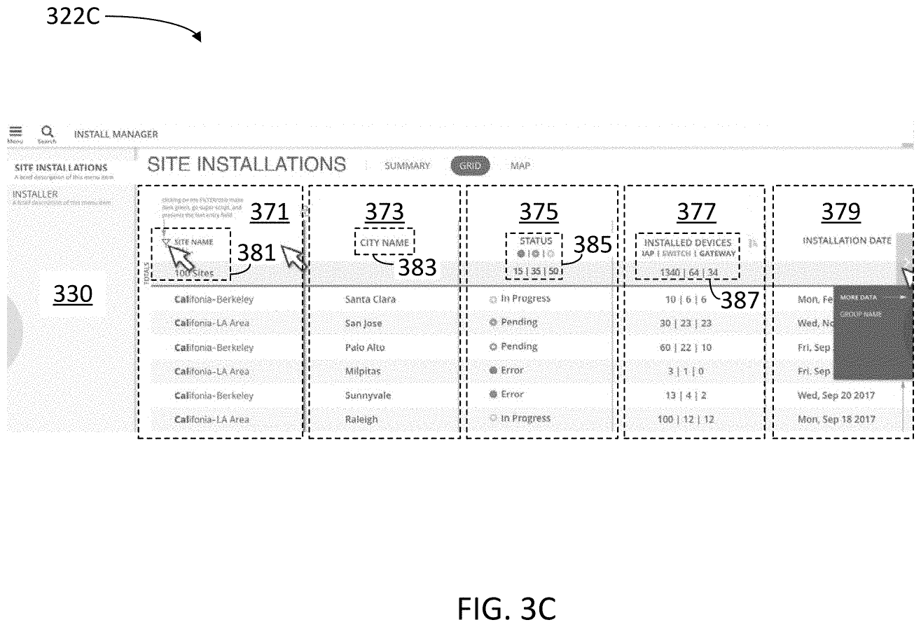

FIGS. 3A-C illustrate dashboard 322A, 322B, and 322C (hereinafter, collectively referred to as “dashboards 322”) in a remote installer control application for a network device installation, according to some embodiments.

FIG. 3A illustrates dashboard 322A for managing multiple installers from an installers tab 330. Fields 331a and 331b include the first names and last names of the installers. Field 333 includes a contact information for each of the installers (e.g., a mobile number, and the like). Field 335 includes a validity period, during which the installer is expected to remain active and authorized to perform installation configurations. Field 337 includes a list of the sites or locations visited by the installer to perform an installation (e.g., locations 120). Field 339 includes a list of the status of each of the installers. The status in field 339 may include any one of (1) an “invited” status: the installer has been invited to download a version of the application in an assigned mobile device; (2) an “active” status: the installer has downloaded the application and is currently on-site, installing a network device; (3) an “inactive” status: the installer has downloaded the application but is not currently installing a network device, and (4) a “registered” status: the installer has been recently entered into the system and has not yet received an invitation to download the application in a mobile device.

FIG. 3B illustrates dashboard 322B set to display a plurality of sites 341 (e.g., locations 120) where network devices have been, or will be, installed. A site name field 350-1 includes the names of the sites where the network devices are located (e.g., a store name, a branch name, and the like). A site address field 350-2 includes the addresses of the sites in field 350-1. In some embodiments, site address field 350-2 may include a link to a map indicating the site. A field 350-3 includes the state or region, or other geographical jurisdiction where the site is located. A network device list 350-4 includes the number and type of network devices installed or to be installed at each site. For example, four (4) access points are installed in store 1. A group name list 350-5 includes the name of the group to which the devices on each site belong to. For example, the four APs installed in store 1, which is in the state of Delaware, belong to a DE-Group. And an installer name list 350-6 includes the name of the installer in charge of the installation of the network devices on each site.

FIG. 3C illustrates dashboard 322C for the site installations of installers 330. A site name field 371 includes a list of site names, which is populated as the user fills in field 381. A field 373 includes more specific site information 383 (e.g., a city name). A status field 375 includes a listing 385 of the total number of network devices and their installation statuses. The installation status may be “error,” “in progress,” or “pending.” An installed device field 377 includes a listing 387 of the total number of network devices of each type (e.g., “TAP,” “Switch,” “Gateway,” etc.) that have been or will be installed. An installation date field 379 includes the date at which each network device has been installed.

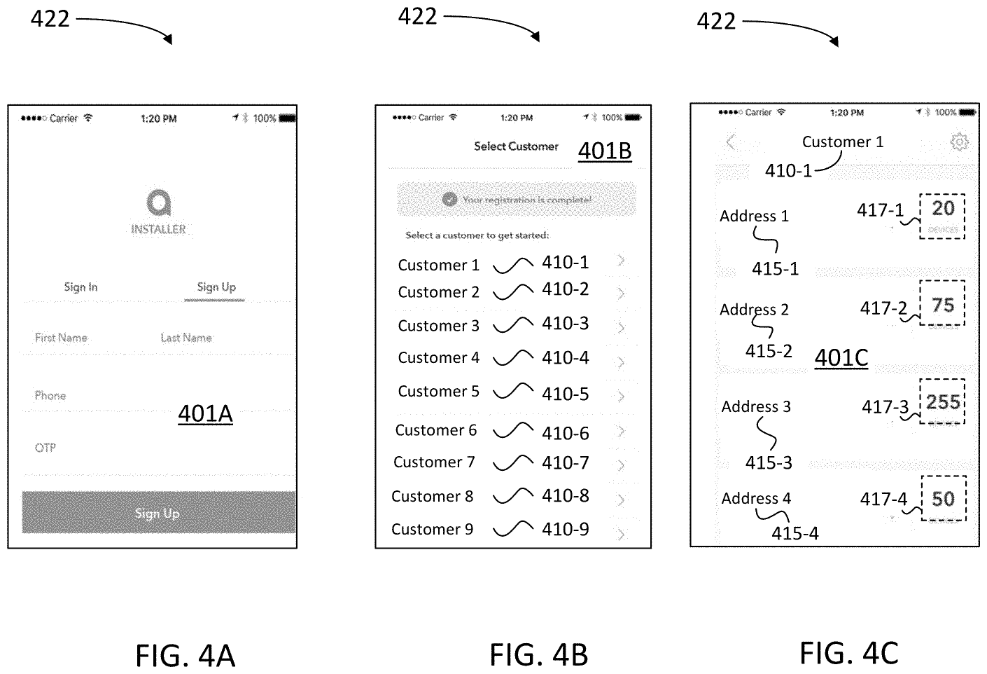

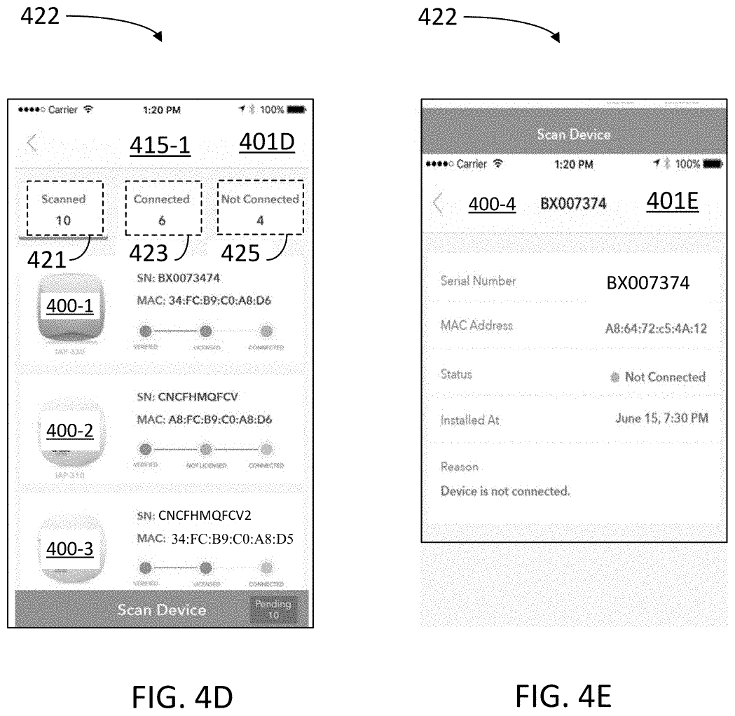

FIGS. 4A-E illustrate screenshots 401A, 401B, 401C, 401D, and 401E (hereinafter, collectively referred to as “screenshots 401”) of an installer application 422 for a network device installation, according to some embodiments. Installer application may be hosted by a server that provides network connectivity services to network devices 400 distributed over multiple locations, among multiple LANs (e.g., WLANs and the like).). Screenshots 401 may be displayed on a display of a smart phone, tablet, palm held device, and the like, used by the installer at an installation site.

FIG. 4A illustrates an access screen shot 401A for application 422. Access screen shot 401A includes login information from the installer (first name, last name, phone no., and the like). With this information, the server may determine whether the installer is authorized to install any given network device, and further evaluate the access, permissions, and privileges for the installer vis a vis each of the network devices that the installer may scan, for installation, maintenance, upgrade, or repair.

FIG. 4B illustrates a customer screenshot 401B including a customer 1 (410-1), a customer 2 (410-2), a customer 3 (410-3), a customer 4 (410-4), a customer 5 (410-5), a customer 6 (410-6), a customer 7 (410-7), a customer 8 (410-8), and a customer 9 (410-9) (hereinafter, collectively referred to as “customers 410”).

FIG. 4C illustrates an address screenshot 401C for a selected one of customers 410 (e.g., Customer 1 410-1). Address screenshot 401C includes address 1 (415-1), address 2 (415-2), address 3 (415-3), and address 4 (415-4), hereinafter, collectively referred to as “addresses 415” indicating the multiple locations in which customer 1 410-1 has a network device installed. Each of addresses 415 is associated with a number of network devices 417-1, 417-2, 417-3, and 417-4, respectively (hereinafter, collectively referred to as “number boxes 417”). For example, and without any loss of generality, customer 1 410-1 has 20 network devices installed in address 1 415-1. Customer 1 410-1 has 75 network devices installed in address 415-2, 255 network devices installed in address 3 415-3, and 50 network devices installed in address 4 415-4. Each of the devices installed across all addresses 415 may have a different installation configuration.

FIG. 4D illustrates screenshot 401D illustrating manufacture serial number, media access control (MAC) address, and installation condition of at least some of the network devices 400-1, 400-2, and 400-3 (hereinafter, collectively referred to as “network devices 400”) installed in a given location (e.g., address 415-1 for customer 410-1). Note that although only manufacture serial number and MAC address are shown in the illustrated example, other unique device identifiers can be used in the similar fashion. Screenshot 401D illustrates that, from the total of 20 devices in address 415-1 for customer 410-1, ten (10) have been scanned (box 421) according to embodiments as disclosed herein, six (6) are successfully connected to the network (box 423), and four (4) are not connected to the network (box 425). The installation condition may include three states: “verified,” when the installation configuration is matched with a network device ID or type, “licensed,” when the installation configuration is licensed to be installed on a specific network device, and “connected,” when the network device is sending and receiving data packets from the network (e.g., the LAN).

For example, and without loss of generality, network device 400-1 has a Serial No. BX0073473, a MAC address 34:FC:B9:C0:AB:D6, and has been verified and licensed, but is not connected to the network. Network device 400-2 has a Serial No. CNCFHMQFCV, a MAC address A8:FC:B9:C0:A8:D6, and has been verified but is not licensed and is not connected. Network device 400-3 has a Serial No. CNCFHMQFCV2, a MAC address 34:FC:B9:C0:A8:D5 (e.g., same as network device 400-1), and has been verified and licensed, but is not connected to the network.

FIG. 4E illustrates screenshot 401E illustrating a scan screen of one of network devices 400 (e.g., network device 400-1). Accordingly, when the installer scans device 400-1, installer application 422 displays in screenshot 401E the Serial No. (e.g., BX007374), the MAC address (e.g., A8:64:72:c5:4A:12), and the installation condition of a network device 400-4 (e.g., “not connected”). Screenshot 401E may also include a date and time when network device 400-4 was installed, and further notes or comments as to the status of the network device.

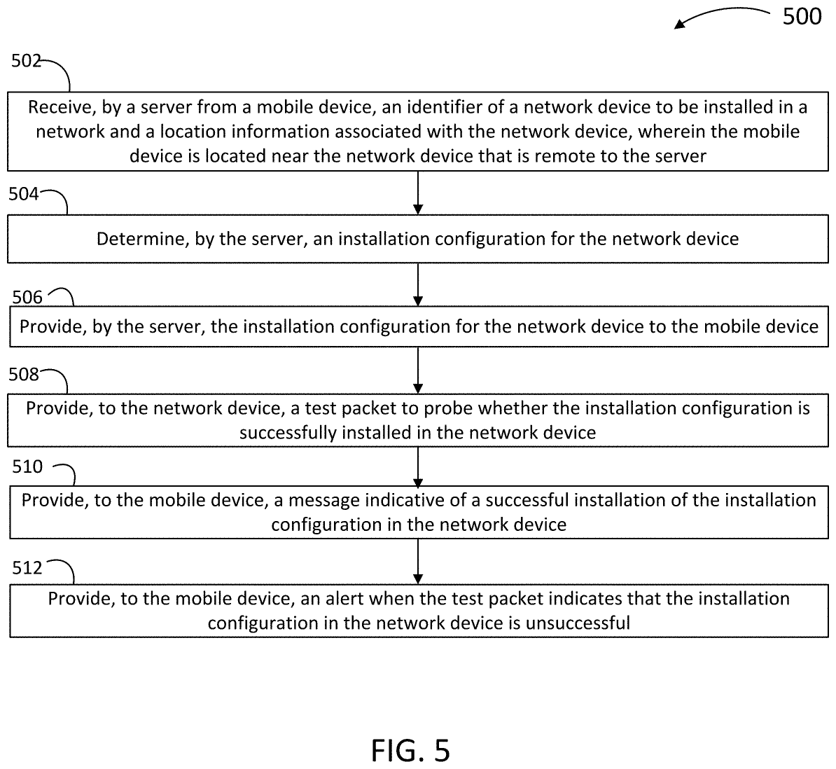

FIG. 5 is a flow chart illustrating steps in a method 500 for remotely controlling a network device installation, according to some embodiments. Method 500 may be performed at least partially by any one of multiple network devices, while communicating with any one of a plurality of client devices (e.g., any one of server 130 and any one of client devices 110). The network device may be hosting a network analysis engine configured to perform at least a portion of an application installed in a client device (e.g., application 222). The client devices may be handled by a user, wherein the user may be an administrator of network 150. At least some of the steps in method 500 may be performed by a computer having a processor executing commands stored in a memory of the computer (e.g., processors 212 and 236, memories 220 and 232). Further, steps as disclosed in method 600 may include retrieving, editing, and/or storing files in a database that is part of, or is communicably coupled to, the computer, using, inter alia, a network analysis engine (e.g., install configuration engine 242). The database may include any one of a configuration and state database, and a time series database (e.g., installation log database 252A and installer database 252B). Methods consistent with the present disclosure may include at least some, but not all, of the steps illustrated in method 500, performed in a different sequence. Furthermore, methods consistent with the present disclosure may include at least two or more steps as in method 500 performed overlapping in time, or almost simultaneously.

Step 502 includes receiving, by the server from the mobile device, an identifier of a network device to be installed in a network and a location information associated with the network device, wherein the mobile device is located near the network device that is remote to the server. In some embodiments, step 502 includes accessing a location information from the mobile device.

Step 504 includes determining, by the server, an installation configuration for the network device. In some embodiments, step 504 includes matching the location information with a configuration group associated to the location information. In some embodiments, step 504 includes verifying a mobile device license and a network device license.

Step 506 includes providing, by the server, the installation configuration for the network device to the mobile device.

Step 508 includes providing, to the network device, a test packet to probe whether the installation configuration is successfully installed in the network device.

Step 510 includes providing, to the mobile device, a message indicative of a successful installation of the installation configuration in the network device.

Step 512 includes providing, to the mobile device, an alert when the test packet indicates that the installation configuration in the network device is unsuccessful. In some embodiments, step 512 includes verifying that an installer associated with the mobile device is authorized to install the network device using the installation configuration at a site indicated by the location information. In some embodiments, step 512 includes selecting a type and a specification parameter of the network device for determining the installation configuration for the network device. In some embodiments, step 512 includes storing the installation configuration in an installation log, and associating a log entry in the installation log to the network device and the mobile device.

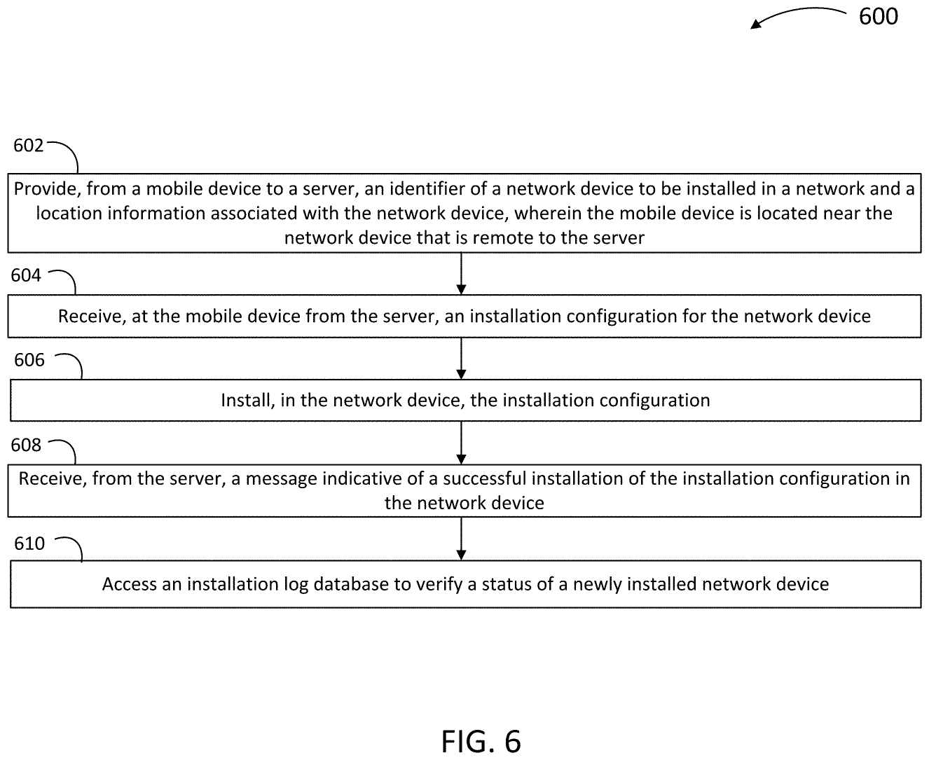

FIG. 6 is a flow chart illustrating steps in a method 600 for a network device installation with a location-specific remotely downloaded configuration, according to some embodiments. Method 600 may be performed at least partially by any one of multiple network devices, while communicating with any one of a plurality of client devices (e.g., any one of server 130 and any one of client devices 110). The network device may be hosting a network analysis engine configured to perform at least a portion of an application installed in at least one of the client devices (e.g., application 222). The client devices may be handled by a user, wherein the user may be an administrator of network 150. At least some of the steps in method 600 may be performed by a computer having a processor executing commands stored in a memory of the computer (e.g., processors 212 and 236, memories 220 and 232). Further, steps as disclosed in method 600 may include retrieving, editing, and/or storing files in a database that is part of, or is communicably coupled to, the computer, using, inter alia, a network analysis engine (e.g., install configuration engine 242). The database may include any one of a configuration and state database, and a time series database (e.g., installation log database 252A and installer 252B). Methods consistent with the present disclosure may include at least some, but not all, of the steps illustrated in method 600, performed in a different sequence. Furthermore, methods consistent with the present disclosure may include at least two or more steps as in method 600 performed overlapping in time, or almost simultaneously.

Step 602 includes providing, from the mobile device to the server, an identifier of a network device to be installed in a network and a location information associated with the network device, wherein the mobile device is located near the network device that is remote to the server. In some embodiments, step 602 includes scanning, from the network device, a tag, and providing the tag to the server.

Step 604 includes receiving, at the mobile device from the server, an installation configuration for the network device.

Step 606 includes installing, in the network device, the installation configuration.

Step 608 includes receiving, from the server, a message indicative of a successful installation of the installation configuration in the network device.

Step 610 includes accessing an installation log database to verify a status of a newly installed network device.

### Hardware Overview

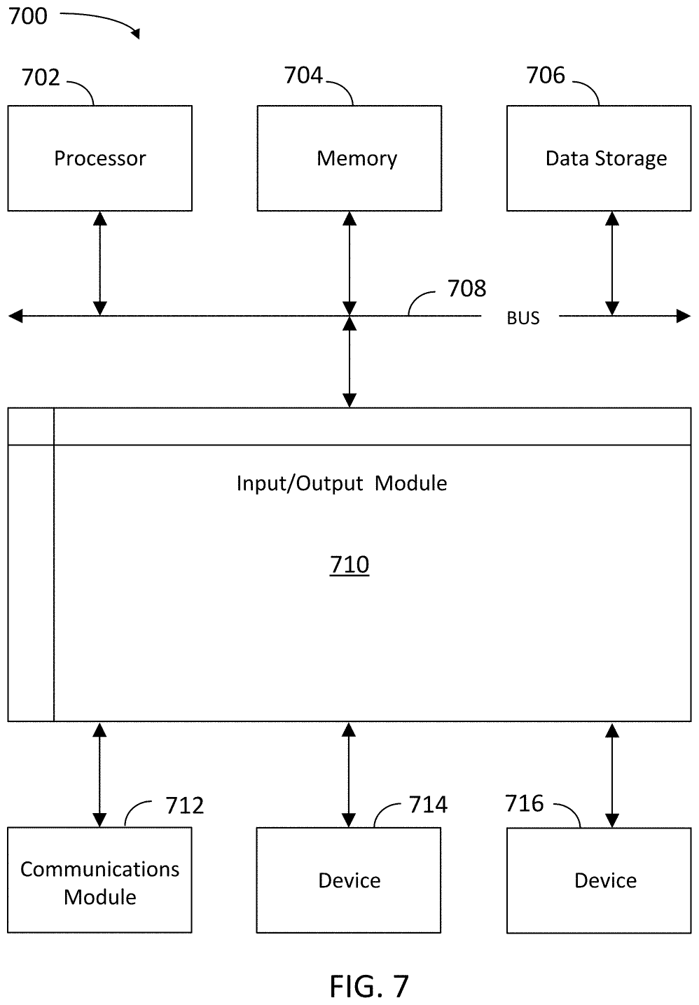

FIG. 7 is a block diagram illustrating an exemplary computer system 700 with which the client device 110 and server 130 of FIGS. 1 and 2, and the methods of FIGS. 5 and 6, can be implemented. In certain aspects, the computer system 700 may be implemented using hardware or a combination of software and hardware, either in a dedicated network device, or integrated into another entity, or distributed across multiple entities.

Computer system 700 (e.g., client device 110 and server 130) includes a bus 708 or other communication mechanism for communicating information, and a processor 702 (e.g., processors 212 and 236) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memories 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, e.g., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage 706 such as a magnetic disk or optical disk, coupled to bus 708 for storing information and instructions. Computer system 700 may be coupled via input/output module 710 to various devices. Input/output module 710 can be any input/output module. Exemplary input/output modules 710 include data ports such as USB ports. The input/output module 710 is configured to connect to a communications module 712. Exemplary communications modules 712 (e.g., communications modules 218 and 238) include networking interface cards, such as Ethernet cards and modems. In certain aspects, input/output module 710 is configured to connect to a plurality of devices, such as an input device 714 (e.g., input device 214) and/or an output device 716 (e.g., output device 216). Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 716 include display devices, such as an LCD (liquid crystal display) monitor, for displaying information to the user.

According to one aspect of the present disclosure, the client device 110 and server 130 can be implemented using a computer system 700 in response to processor 702 executing one or more sequences of one or more instructions contained in memory 704. Such instructions may be read into memory 704 from another machine-readable medium, such as data storage 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data network device, or that includes a middleware component, e.g., an application network device, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and network devices. A client and network device are generally remote from each other and typically interact through a communication network. The relationship of client and network device arises by virtue of computer programs running on the respective computers and having a client-network device relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage 706. Volatile media include dynamic memory, such as memory 704. Transmission media include coaxial cables, copper wire, and fiber optics, including the wires forming bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method, comprising:
receiving, by a server from a mobile device, an identifier of a network device to be installed in a network and a location information for a location which includes the network device, wherein the mobile device is located near the network device that is remote to the server;
determining, by the server, an installation configuration for the network device, wherein determining the installation configuration for the network device comprises matching, by the server, the location information with configuration settings for the location which includes the network device; and
providing, by the server, the installation configuration for the network device to the mobile device.

2. The computer-implemented method of claim 1, wherein receiving the location information for the location which includes the network device comprises accessing a location information from the mobile device.

3. The computer-implemented method of claim 1, wherein determining an installation configuration for the network device comprises verifying a mobile device license and a network device license.

4. (canceled)

5. The computer-implemented method of claim 1, further comprising verifying that an installer using the mobile device is authorized to install the network device using the installation configuration at a site indicated by the location information.

6. The computer-implemented method of claim 1, further comprising selecting a type and a specification parameter of the network device for determining the installation configuration for the network device.

7. The computer-implemented method of claim 1, further comprising providing to the network device a test packet to probe whether the installation configuration is successfully installed in the network device.

8. The computer-implemented method of claim 1, further comprising providing, to the mobile device, an alert when a test packet indicates that the installation configuration in the network device is unsuccessful.

9. The computer-implemented method of claim 1, further comprising storing the installation configuration in an installation log, and associating a log entry in the installation log to the network device and the mobile device.

10. The computer-implemented method of claim 1, further comprising providing to the mobile device a message indicative of a successful installation of the installation configuration in the network device.

11. A system, comprising:
a memory storing instructions; and
one or more processors configured to execute the instructions to:
receive, by a server from a mobile device, an identifier of a network device to be installed in a network and a location information for a location which includes the network device, wherein the mobile device is located near the network device that is remote to the server;
determine, by the server, an installation configuration for the network device, wherein determining the installation configuration for the network device comprises matching, by the server, the location information with configuration settings for the location which includes the network device; and
provide, by the server, the installation configuration for the network device to the mobile device.

12. The system of claim 11, wherein the one or more processors further execute instructions to provide to the mobile device a message indicative of a successful installation of the installation configuration in the network device.

13. (canceled)

14. The system of claim 11, wherein the one or more processors further execute instructions to verify that an installer using the mobile device is authorized to install the network device using the installation configuration at a site indicated by the location information.

15. The system of claim 11, wherein the one or more processors further execute instructions to select a type and a specification parameter of the network device to determine the installation configuration for the network device.

16. The system of claim 11, wherein the one or more processors further execute instructions to provide to the network device a test packet to probe whether the installation configuration is successfully installed in the network device.

17. A computer-implemented method, comprising:
providing, from a mobile device to a server, an identifier of a network device to be installed in a network and a location information for a location which includes the network device, wherein the mobile device is located near the network device that is remote to the server;
receiving, at the mobile device from the server, an installation configuration for the network device, wherein the installation configuration for the network device is determined based on matching the location information with configuration settings for the location which includes the network device; and
installing, in the network device, the installation configuration.

18. The computer-implemented method of claim 17, wherein providing the identifier of the network device comprises scanning, from the network device, a tag, and providing the tag to the server.

19. The computer-implemented method of claim 17, further comprising receiving, from the server, a message indicative of a successful installation of the installation configuration in the network device.

20. The computer-implemented method of claim 17, further comprising accessing an installation log database to verify a status of a newly installed network device.
